(19) United States
(12) Patent Application Publication
(10) Pub. No.: US 2006/0162845 A1
(43) Pub. Date: Jul. 27, 2006

(54) Method of sealing a crack against water seepage

(76) Inventors: Michele M. Bogard, Ballwin, MO (US); Craig A. Bogard, Ballwin, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/041,323

(22) Filed: Jan. 24, 2005

(51) Int. Cl. B32B 43/00

(52) U.S. Cl. 156/94

(57) ABSTRACT

A method of sealing a crack in a first material is provided in which the repair seals and stabilizes the first material. The longitudinal axis of the crack is determined. A carbon fiber material in which the fibers of the material have warp and weft direction is applied to the crack so that at least one of the warp and weft directions of the fiber is generally perpendicular to the longitudinal axis of the crack.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates to a method of sealing a crack to prevent water seepage. While the invention is described in particular detail with respect to masonry walls, those skilled in the art will recognize the wider applicability of the inventive principals disclose hereinafter.

The prevalent method of replacing or repairing a crack in a masonry or concrete wall presently involves a process known as epoxy injection. In this method, the crack commonly is filled with a suitable epoxy, which cures in a conventional manner. Epoxy injection is simply a way to seal a crack to prevent seepage. However, this process does not take into account the fact that when a concrete wall has cracks all the way through it, the concrete has lost one hundred percent (100%) of its tensile strength. Since the concrete wall has lost its strength, it becomes vulnerable to continuous shifting or moving from (i) the pressure caused by the weight of the soil acting against it, (ii) the expansion and contraction of the soil, and (iii) the pressure caused by excessive rain, i.e., the additional water pressure from rain acting on the wall. Eventually, as the wall continues to move, the epoxy injection repair tends to crack or the concrete loses its bond with the epoxy. When this occurs, water seepage returns.

The method of the invention disclosed hereinafter is designed not only to seal the crack, but also to stabilize the concrete surrounding the crack, making a repair permanent. In addition, repairs made with the method of the present invention are aesthetically pleasing to the eye. After repair, the work done on the crack, for practical purposes disappears beneath a coat of paint.

### BRIEF SUMMARY OF THE INVENTION

In accordance with this invention, and generally stated, a carbon fiber material having warp and weft weave of the fibers is sized generally to overlay a crack in a masonry wall. The crack normally has an irregular shaped longitudinal axis. The crack is cleaned to remove loose material and filled with a suitable paste filler. The carbon fiber is bonded to the wall so that at least one of the warp and weft directions of fiber is placed generally perpendicular to the length axis of the crack. Aesthetic finishes may be applied to the repair, if desired.

### BRIEF DESCRIPTION OF THE SEVERAL VIEWS OF THE DRAWINGS

The objects of the invention are achieved as set forth in the illustrative embodiments shown in the drawings, which form a part of this specification.

FIG. 1 is a view, partly broken away, of a prior art epoxy injection repair made to a crack in a masonry wall;

FIG. 2 is a view, partly broken away, of a repair made in accordance with the principles of this invention to a crack in a masonry wall, the crack originally extending in a general vertical direction;

FIG. 3 is a view, partly broken away, of a repair made in accordance with the principles of this invention to a crack in a masonry wall, the crack originally extending in a general horizontal direction; and

FIG. 4 is a cross sectional view taken along the line 4-4 of FIG. 2 illustrating a preferred application process for the method of this invention.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. As various changes could be made in the constructions discussed herein without departing from the scope of the invention, it is intended that all matter contained in the description or shown in the accompanying drawings shall be interpreted as illustrative and not in a limiting sense.

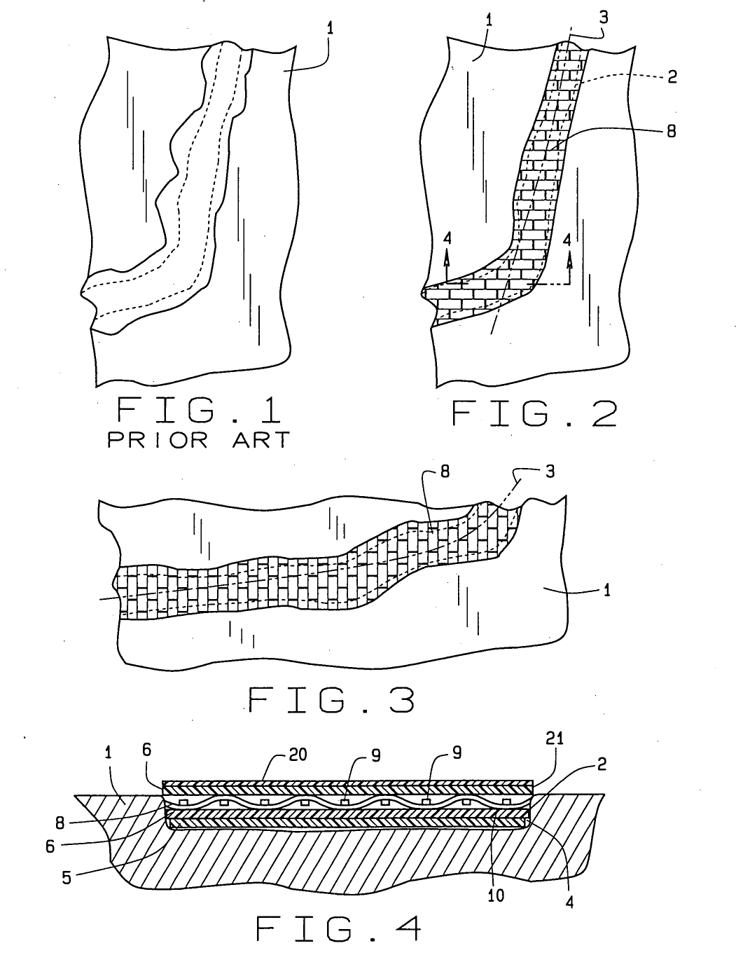

Referring now to FIG. 1, reference numeral 1 indicates a masonry wall, commonly of a poured concrete or similar material forming a foundation of a building not shown, for example. As will be appreciated by those skilled of the art, the wall 1 commonly is below grade, and soil commonly is backed filled against the exterior surface of the wall 1. While there been numerous attempts to find a mixture for a concrete wall that does not crack, the goal has been elusive. Commonly, concrete cracks over time. Often those cracks are accompanied by water seepage. Foundation or floor seepage in buildings is undesirable, regardless of the use of the building if for no other reason than the potential for mold being formed because of the seepage. In a residential building, for example, basements or lower levels often are finished, and water seepage causes additional damage. For purposes of the specification, cracks with which the invention finds application are intended to be 1 inch in width or smaller, as larger cracks are indicative of substantially greater foundation problems then the common cracks which commonly form in concrete floors and walls.

As indicated above, epoxy injection has been the normal method for repairing the cracks described above. FIG. 1 illustrates the application of epoxy injection, the repair method commonly found in the prior art. For the reasons given above, epoxy injection is an inferior repair method.

FIGS. 2, 3 and 4 show one illustrative embodiment of the method of the present invention, which we have found to work well. As there shown, a crack 2 formed in the wall 1 is first prepared for further treatment by grinding the crack 2 to remove loose material and to break any bond along the surface of the concrete along the crack 2. While the crack 2 often has an erratic shape, the crack 2 a general longitudinal axis 3 normally is determined merely by visual observation.

A primer coat 4 is applied to the area of the crack 2. The purpose of the primer coat 4 is to impregnate the concrete along and about the crack 2. Preferably, the primer coat 4 has a tensile strength of 2000 PSI and a tensile strain of 0.3%. After application of the primer coat 4, the crack 2 is filled with paste filler 5. The paste filler 5 preferably has a tensile strength of 2000 PSI and a tensile strain of 0.05%.

Once the paste filler 5 sets, a bonding adhesive 6 is applied to the crack 2 area. Application of the bonding adhesive 6 may be accomplished in a variety of ways. A conventional roller applicator work well, for example. Preferably the bonding adhesive has a tensile strength of 7000 PSI and a tensile strain of 0.03%.

A carbon fiber sheet 8 then is prepared for application. The sheet 8 is a woven material having a warp direction 9 and a weft direction 10. The sheet 8 also has a width dimension, which in application use is chosen so that the sheet 8 extends beyond the width dimension of the crack 2. The length of the sheet 8 preferably is applied as one-piece length of material. However, the length and/or width of the crack 2 may require the crack 2 to be covered by a plurality of smaller lengths of the sheet 8. In either case, at least one of the warp and a weft direction of the sheet 8 is placed so that threads of the carbon fiber material generally are perpendicular to the axis 3 of the crack 2. Preferably the sheet 8 has a tensile strength of 500,000 PSI and a tensile strain of 1.5%.

The sheet 8 is placed directly on the adhesive 6. Commonly the sheet 8 is placed by hand, although other application methods are compatible with the broader aspects of this invention. After placement, a rib roller is rolled over the sheet 8 to force the adhesive 6 between the fibers of the sheet 8. Thereafter, a second coat of adhesive 6 is applied to the sheet 8. A rib roller is again rolled over the sheet 8 to force the adhesive 6 between the fibers of the sheet 8.

After application, the adhesive 6 is allowed to cure. Curing causes the sheet 8 to form a secure bond with the wall 1. As indicated above, following cure, the area of the crack 2 may be painted with a conventional paint to form a coating 20. The coating 20 enhances the aesthetic appearance of the repair. This method of application is best seen in FIG. 4. As there shown, the final composite repair includes the primer coat 4, the filler 5, the first adhesive application 6, the sheet 8 the second adhesive application 6 and the final coating 20. Those skilled in the art will recognize that FIG. 4 is not to scale, and that any edge 21 existing after repair may be feathered into a smooth surface with the surrounding area of the wall 1.

In view of the above, it will be seen that several objects and advantages of the present invention have been achieved and other advantageous results have been obtained. Numerous variations, within the scope of the appended claims, will be apparent to those skilled in the art. For example, the width of the sheet 8 preferably is about 1 foot, and the sheet 8 may be formed into rolls. While certain that materials were described as preferred, other materials may be employed, if desired. One or more of the layers described in conjunction with FIG. 4 may be eliminated or additional layers may be applied in other embodiments of the invention. These variations are merely illustrative.

Having thus described the invention, what is claimed and desired to be secured by Letters Patent is:

1. A method of sealing a crack in a first material against water seepage, comprising the steps:
preparing the area of the crack by removing loose material;
applying a primer coat of material to impregnate the crack area;
applying a paste filler to the crack;
applying a bonding adhesive over the area of the crack;
placing a carbon fiber sheet material over the bonding adhesive such as carbon fibers are generally perpendicular to the crack;
applying pressure to the carbon fiber sheet, to ensure the bonding adhesive impregnates the carbon fiber sheet; and
applying a second coat of bonding adhesive.

2. The method of claim 1 wherein the pressure applying step is accomplished with a rib roller.

3. The method of claim 2 wherein the preparing step includes grinding away a loose material.

4. The method of claim 3 further including a second pressure applying step one in time after the application of the second bonding adhesive step.

5. The method of claim 4 wherein the carbon fiber sheet is a strip of material having a width dimension of approximately 1 foot.

6. The method of claim 5 wherein the steps are accomplished sequentially.

7. The method of claim 6 wherein the first material is a masonry material.

8. The method of claim the 7 wherein the carbon fiber sheet material has a warp and a weft direction and at least one of the directions is positioned generally perpendicular to the axis of the crack.

9. The method of sealing a crack in the masonry wall comprising the steps:
grinding the area of the crack to break the masonry seal and remove loose material;
determining the general axis of the crack;
filling the crack;
bonding a fiber sheet to the wall along the crack, the fiber sheet having a warp direction and a weft direction, the bonding step including placing one of the warp and a weft directions of fiber generally perpendicular to the axis of the crack.

10. The method of claim 9 wherein the fiber sheet is a strip of material.

11. The method of claim 10 wherein the strip of material is approximately 1 foot wide.

12. A method of sealing a crack in a masonry wall, the crack having a width dimension and a longitudinal axis, comprising the steps:
preparing a carbon fiber strip of material having a warp direction and a weft direction, the strip of material overlaying the crack in the least the width dimension of the crack;
grinding the area of the crack to break the masonry seal and remove loose material;
determining the general direction for the axis of the crack;
filling the crack;
bonding the carbon fiber strip of material to the wall along the crack so that at least one of the warp and a weft directions of the fiber lie generally perpendicular to the axis of the crack.
